(19) United States
(12) Patent Application Publication
(10) Pub. No.: US 2009/0189854 A1
(43) Pub. Date: Jul. 30, 2009

(54) USER INTERFACE CONTROLLER FOR A COMPUTER

(76) Inventor: Ulrich Schwanecke, Wiesbaden (DE)

Correspondence Address: Nixon Peabody LLP, 200 Page Mill Road, Suite 200, Palo Alto, CA, 94306, US

(21) Appl. No.: 12/363,763

(22) Filed: Feb. 1, 2009

Related U.S. Application Data
(63) Continuation of application No. PCT/EP2007/057401, filed on Jul. 17, 2007.

(30) Foreign Application Priority Data
Aug. 1, 2006 (DE) 10 2006 036 160.1

(51) Int. Cl. G09G 5/00

(52) U.S. Cl. 345/156

(57) ABSTRACT

User interface controller for controlling a computer comprising:
a platform, which is designed such that for use it rests parallel to the floor and which is strong enough and large enough that a person can stand on the platform,
at least one sensor, which is disposed underneath or inside the platform and which records the person's movement on the platform and converts it into an electronic signal,
a controller which receives the sensor's electronic signals and converts them into digital signals which can be processed by the computer such that the movements can be interpreted as a user input.

### PRIORITY CLAIM

This application is a continuation of PCT/EP2007/057401 filed Jul. 17, 2007, which claims priority to DE 10 2006 036 160.1 filed Aug. 1, 2006, both of which are incorporated by reference.

### FIELD OF THE INVENTION

The invention relates to a user interface for controlling a computer. In particular, the invention relates to an interface which is controlled by means of user movements. The invention further relates to a balance board, having a curvature under the platform in which sensors are installed for inclination.

### BACKGROUND

In addition to the standard user interfaces of keyboard and mouse, there is a range of devices that facilitate problem or task-oriented man-machine interactions. Many graphics-oriented tasks, for example, can be better solved with a digitizer tablet than with a mouse. In the area of computer games, there now exists an almost incalculable number of different controllers, starting with simple game controllers to controllers that imitate weapons and culminating in sophisticated hydraulic platforms such as those often found in the case of arcade sports games in amusement arcades.

Balance training boards which implement control of the computer by means of pressure and inclination sensors (DE29612734U), ball sensor (DE69501446T2) or filament sensor (DE19837963A1) are known in the prior art.

Furthermore, a sensor was described in DE202005011704U where a clapper was attached to potentiometers.

DE 10117125A1 describes a trackball with which control of the computer is achieved by means of a platform resting on the ball.

Moreover, a platform which is pressed upwards by springs may also assume control of the computer by means of contacts attached laterally (DE 4004554A1).

These inventions have the disadvantage that the electrical signals generated by the contacts still have to be converted first of all into computer-readable signals. The drawback of this in production is that a potential licensee requires electronics workshops.

All these interfaces are intended to increase the level of immersion in the corresponding world of work or play.

### SUMMARY OF THE INVENTION

The present invention is supposed to increase the level of immersion for the whole body. Since control commands require use of the whole body, immersion in the appropriate applications is increased significantly. In addition, a series of new application fields arises in a medical environment, for example, where proprioceptive coordination boards have been in use for a long time, although without connection to a computer. Moreover, the area of sports theory and exercise prescription may also be important. The present invention might gain widespread distribution due to its inexpensive construction.

In particular, the object of the invention is to provide an inexpensive balance board whereby there is no need for work such as soldering, etching or assembling of circuit boards or programming of microcontrollers to be carried out in electronics workshops.

This object is achieved by an invention with the features of the independent claims.

The present invention consists in the preferred embodiment of the components described below.

The invention is based on a proprioceptive coordination board, frequently referred to as a rocker-roller, wobble board or balance board. These devices are available in different versions. An inexpensive plastic version was used for the prototype construction. This board is designed such that a person can stand on the board and perform movements.

Thus it is possible to simulate mouse movements as well as entries from the keyboard and other controllers.

The apparatus may have a battery compartment in addition to an on/off switch and a reset button in the interior of the preferably domed or hollow board.

A series of sensors is conceivable in order to use the movements of a proprioceptive coordination board as a user interface. Thus it is possible, for example, to use an inertial tracker (measurement of the orientation and position changes arising from changes in acceleration) such as is supplied amongst others by the Intersense [INT] company.

One aim, however, was the development of an inexpensive user interface which would also make it possible to use cheaper sensors.

Thus in one embodiment, movement sensors were used having an arrangement of four inclination switches each offset by 90 degrees.

These are preferably soldered to a printed circuit board. The connections may be routed outwards such that an external transformer unit may be used. It is also conceivable to accommodate the logic circuit in the board such that only one cable or, in the case of a wireless connection, no external connections are present.

Unlike the digital variant, the analog system also detects the degree of inclination. This may be brought about with the help of a sensor which is implemented in a similar manner to a wireless mouse. This glides over a steel plate attached inside the balance board and transmits the movements to a connected computer via wireless or cable. A vibration motor, which prevents any static friction otherwise occurring, may be used to achieve better response.

This object is achieved according to the invention by the integration of a mouse as a component in the balance board. In the present invention, the mouse is introduced in such a way that a metal plate is located above the sensor. This metal plate is attached to the curvature or the platform by a wire such that the plate can oscillate. During use, the cursor begins to dither. Damping is achievable by means of a spring that is fitted over the pendulum wire.

The keystroke may be achieved by means of an air- or wire-based remote release.

Connection of the digital sensors to a computer is effected preferably via the USB port. Other ports such as serial or FireWire ports are conceivable.

For example, an interface was built for this purpose using the KeyWarrior chip. Via this interface, the inclination switches of the digital sensors simulate the operation of various keys of a keyboard or mouse.

In one embodiment, the interface transfers the switching operations of the inclination switches to the computer as operation of the arrow/cursors keys or other keys. In one possible variant, operation of the “asdw” or “jkli” keys may also be simulated. These keys are usually used for controlling computer games. The USB connector for connection to the computer is present on one side of the device. A nine-pin DUSB connector, via which the interface is connected to the digital sensor, is present on another side. The connection may of course be implemented via other connectors (or completely without such connectors).

The invention does not require any special drivers in the preferred embodiment. Since the interface behaves like a keyboard or a mouse in relation to a program, all programs that are controlled via the keyboard or the mouse may be activated without further software. It is of course also conceivable to work with a driver in order to query the individual sensors and to make the system perform appropriate actions. Many games can thus benefit immediately from control by means of dedicated drivers or standard drivers. As an example, reference is made here to TuxRacer (or PlanetPenguinRacer http://projects.planetpenguin.de/racer/), a simple 3D game which is available for most platforms. Control of the racing penguin by means of the invention considerably increases immersion in the game.

### BRIEF DESCRIPTION OF THE FIGURES

The figures on which the preferred embodiments are based are described briefly below.

FIG. 1 shows the device according to the invention with inclination sensors in a lateral sectional view whereby a person is disposed on the platform and an analog sensor is disposed underneath the platform;

FIG. 2 shows the device from FIG. 1 in an inclined position whereby the analog sensor has changed its position;

FIG. 3 shows the device according to the invention with an acceleration sensor in the sectional view;

FIG. 4 shows the device according to the invention with pressure sensors which are disposed in the marginal regions;

FIG. 5 shows an embodiment with pendulum and spring in addition to a frame for attachment of the pendulum;

FIG. 6 shows an embodiment with pendulum and spring in addition to an insert for attachment of the pendulum;

FIG. 7 shows an embodiment with pendulum and spring in addition to attachment of the pendulum on the platform and inserts into the platform (e.g. cover)

FIG. 8 shows an embodiment with pendulum and spring in addition to attachment of the pendulum in the curvature and attachment of the mouse on the platform and inserts into the platform (e.g. cover)

FIG. 9 shows an embodiment with pendulum and spring in addition to attachment of the pendulum to the curvature, attachment of the mouse to the pendulum and creation of a reflective layer underneath the platform

FIG. 10 shows an embodiment with pendulum and spring in addition to attachment of the pendulum on the platform and inserts into the platform, attachment of the mouse to the pendulum and creation of a reflective layer in the curvature.

FIG. 11 shows an embodiment with a reflective layer in the curvature

FIG. 12 shows an embodiment with an inner and an outer curvature and a reflective layer in the inner curvature

FIG. 13 shows an embodiment with an inner and an outer curvature in addition to a reflective layer in the inner curvature

### DETAILED DESCRIPTION OF THE PREFERRED EMBODIMENTS

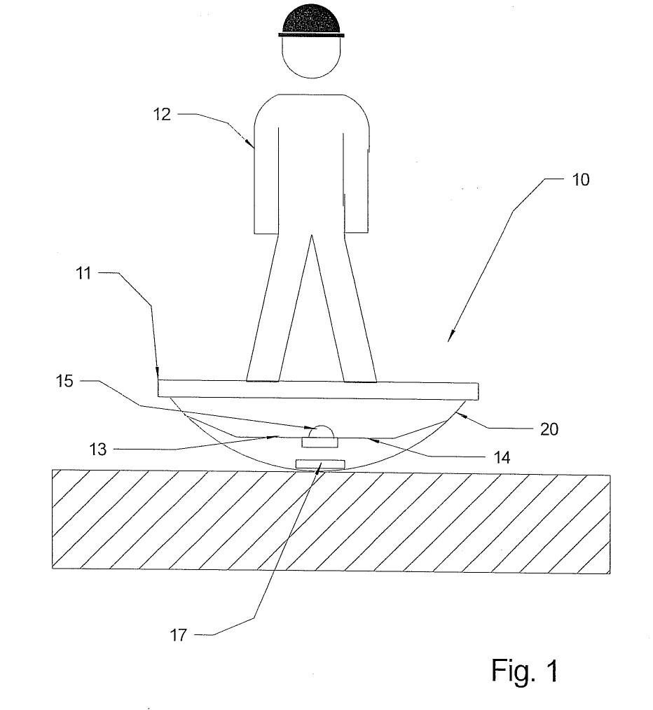

FIG. 1 shows preferred embodiment 10 with a platform 11 under which is disposed a spherical segment 20 such that movements of person 12 on the platform are preferably possible in all directions. Disposed inside the spherical segment is an analog inclination sensor, which detects the inclinations and thus the load changes, and forwards corresponding signals to the computer (not illustrated).

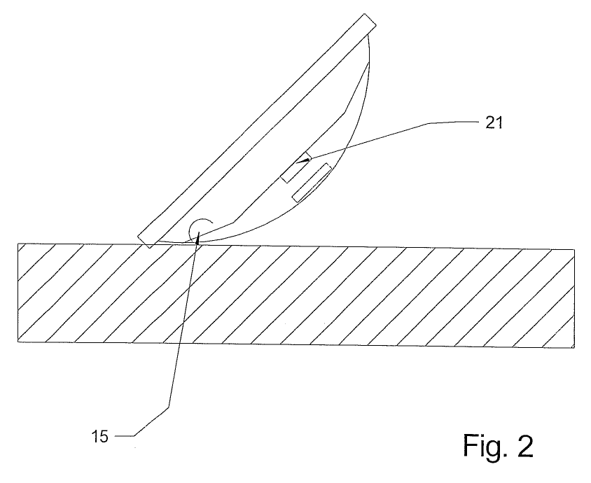

The analog inclination sensor comprises a plate 14 on which glides a sliding sensor 15. The sliding sensor may be a ball or, as in the case illustrated, a computer mouse, which is optical or is provided with a ball, and which passes on the signals by wireless to a receiver, e.g. the computer. Disposed underneath the plate is a vibration drive 21, which is supposed to reduce the frictional resistance. In an alternative embodiment, the vibration motor in the current prototype may be mounted on sliding sensor 15. If, for example, a user puts uneven pressure on the plate, then the plate tilts in one direction and the computer mouse, which is mounted on the plate, slides into the weighted corner. FIG. 2 shows a corresponding situation.

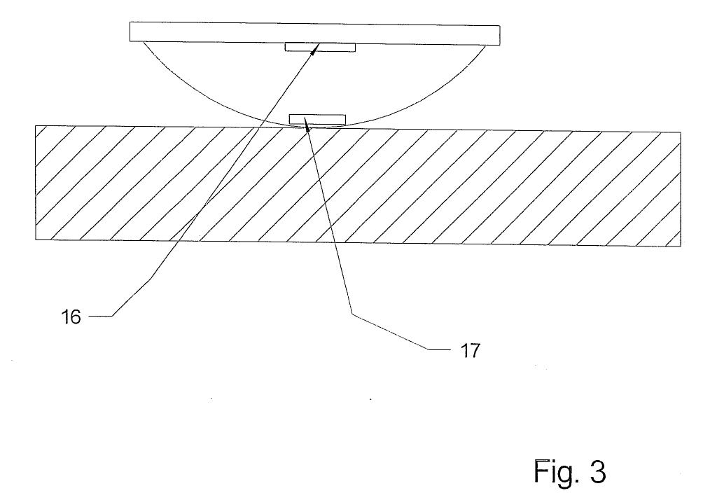

In a possible alternative embodiment, the sensor is an acceleration sensor 16 or also an analog inclination sensor (inertial tracker) which records the movements. FIG. 3 shows a corresponding embodiment. The controller's battery unit or the transformer unit is accommodated in a further region 17.

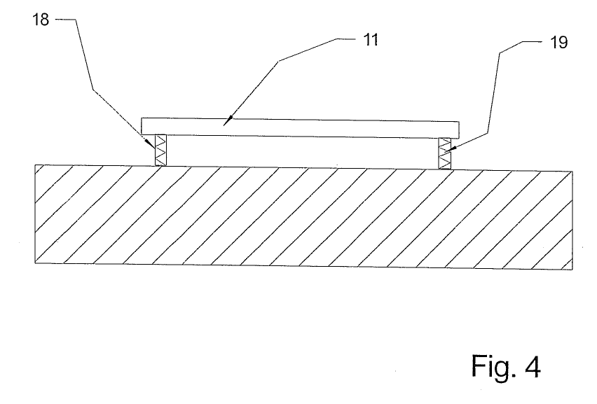

FIG. 4 in turn shows an alternative embodiment in which the platform is supported on feet 18 whereby the feet may either give slightly or may be virtually rigid. In this case the feet are in contact with a pressure sensor 19 which records load changes on the platform.

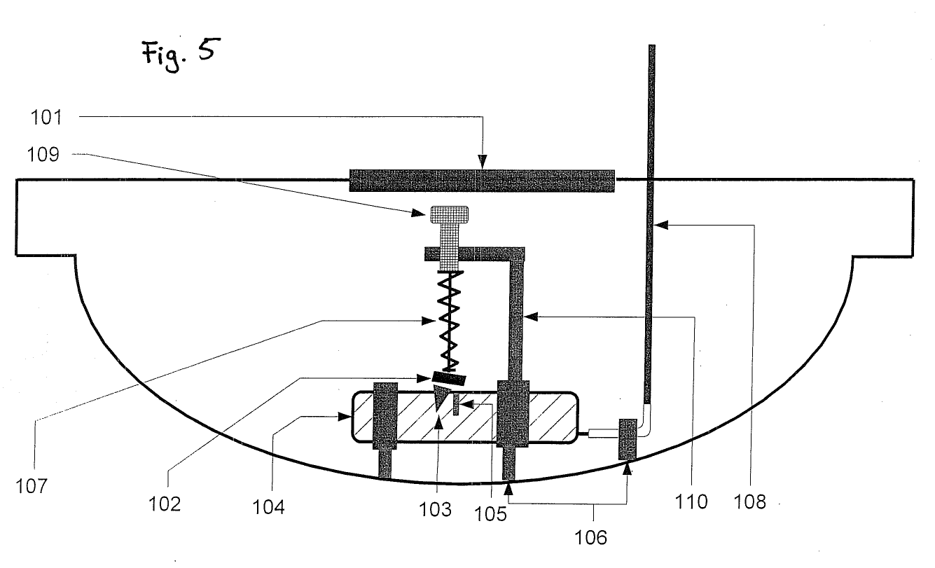

FIG. 5 shows a first embodiment. In a balance board (platform with hemispherical curvature), mountings are used to attach a mouse in the curvature. The mouse's optical sensor faces towards the platform, is aligned centrally and the light emitted by the mouse is reflected onto the optical sensor using a plate. The plate hangs from a pendulum and is attached to a frame. A spring which is fitted over a wire is used to damp the dithering of the mouse pointer during use. Due to attachment of the pendulum wire to the frame, the height of the pendulum does not depend on the deflection of the platform. An adjusting screw is used to fine-tune the height of the plate in relation to the mouse. A keystroke may be triggered by means of a wire- or air-based remote release. In this case, FIG. 5 shows a cover 101, a plate 102 of plastic or metal, a laser 103, a mouse 104, an optical detector 105, a mounting 106 for the mouse, a wire with spring 107, a remote release 108, an adjusting screw 109 and a frame 110 for a wire suspension.

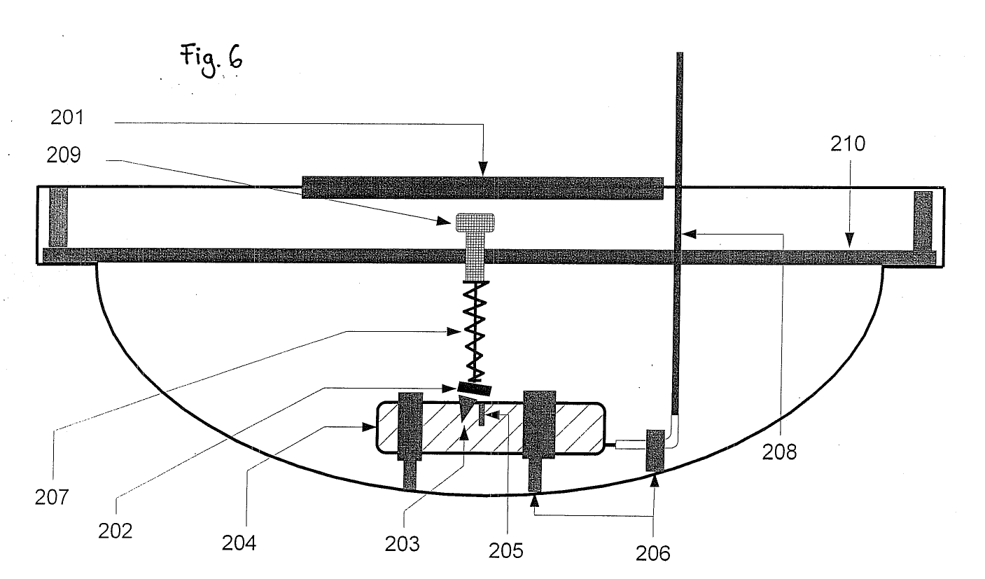

FIG. 6 shows a further embodiment of a balance board (platform with hemispherical curvature). A mouse is attached in the curvature using mountings. The mouse's optical sensor faces towards the platform, is aligned centrally and the light emitted by the mouse is reflected onto the optical sensor using a plate. The plate hangs from a pendulum and is attached to an insert. A spring which is fitted over a wire is used to damp the dithering of the mouse pointer during use. Due to attachment of the pendulum wire to the insert, the height of the pendulum does not depend on the deflection of the platform. An adjusting screw is used to fine-tune the height of the plate in relation to the mouse. A keystroke may be triggered by means of a wire- or air-based remote release (see FIG. 6). Here the parts are referred to as follows: cover 201; plate of plastic or metal 202; laser 203; mouse 204; optical detector 205; mountings for mouse 206; wire with spring 207; remote release 208; adjusting screw 209; insert 210.

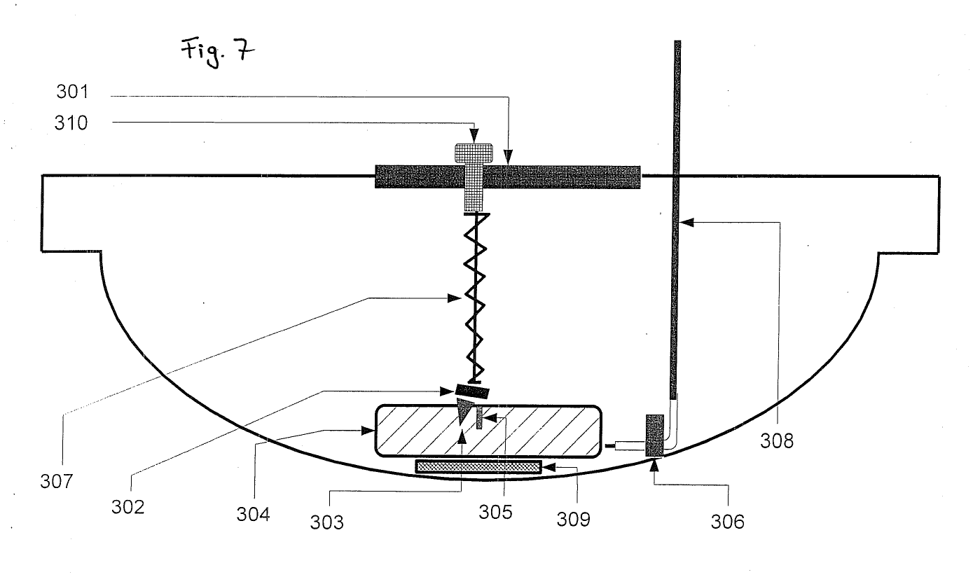

In a further embodiment of a balance board (FIG. 7) (platform with hemispherical curvature), adhesive tape is used to attach a mouse in the curvature. The mouse's optical sensor faces towards the platform, is aligned centrally and the light emitted by the mouse is reflected onto the optical sensor using a plate. The plate hangs on the pendulum and is attached to the platform or to a cover set into the platform. A spring which is fitted over a wire is used to damp the dithering of the mouse pointer during use. Due to attachment of the pendulum wire to the platform or the cover in the platform, the height of the pendulum depends on the deflection of the platform. An adjusting screw is used to fine-tune the height of the plate in relation to the mouse. A keystroke may be triggered by means of a wire- or air-based remote release (see FIG. 3). FIG. 3 shows a cover 301, a plate of plastic or metal 302, a laser 303, a mouse 304, an optical detector 305, mountings for a remote release 306, a wire with spring 307, a remote release 308, adhesive or adhesive tape for attachment of the mouse 309 and an adjusting screw 310.

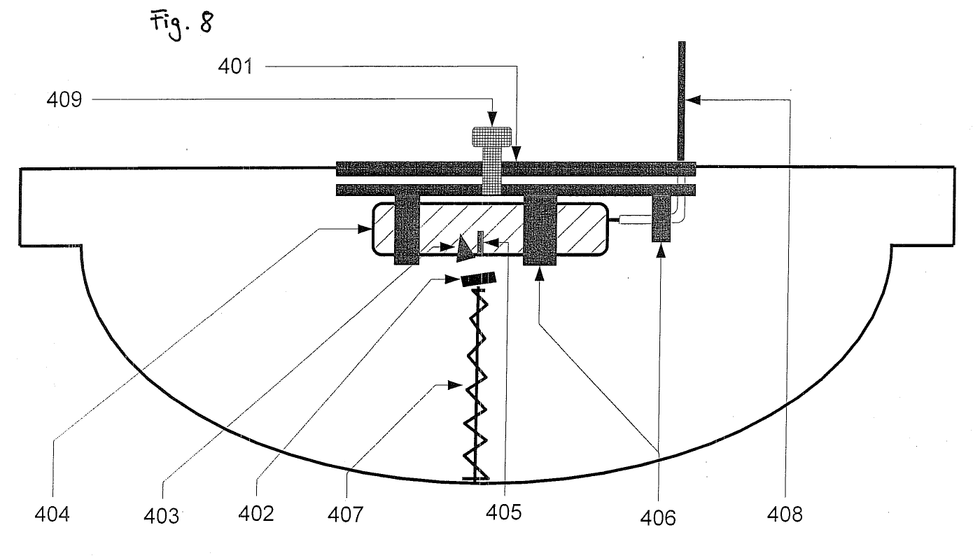

In a further embodiment (FIG. 8) of the balance board (platform with hemispherical curvature), mountings are used to attach a mouse to a height-adjustable cover that is set into the platform. The mouse's optical sensor faces towards the curvature and the light emitted by the mouse is reflected onto the optical sensor using a plate. A pendulum wire is attached in the curvature and points towards the platform and is terminated by a plate. A spring which is fitted over the wire is used to damp the dithering of the mouse pointer during use. Due to attachment of the mouse to the platform's height-adjustable cover, the height of the mouse in relation to the pendulum depends on the deflection of the platform. An adjusting screw is used to fine-tune the height of the mouse in relation to the plate. A keystroke may be triggered by means of a wire- or air-based remote release (see FIG. 8). This embodiment comprises a height-adjustable cover 401, a plate of plastic or metal 402, a laser 403, a mouse 404, an optical detector 405, mountings for mouse 406, wire with spring 407; remote release 408; adjusting screw 409.

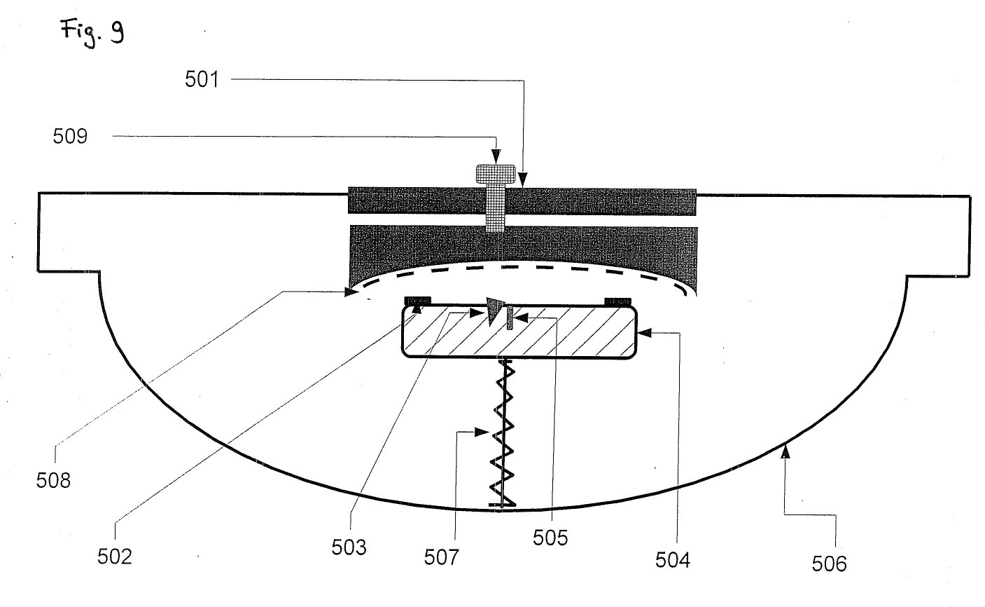

In another further embodiment, a pendulum wire is attached in the curvature in a balance board (FIG. 9) (platform with hemispherical curvature). A mouse is mounted on the pendulum wire as a termination. A spring which is fitted over the wire is used to damp the dithering of the mouse pointer during use. The platform has a height-adjustable cover which is set into the platform. This cover is coated on the side facing the curvature with a reflective layer (paint and lacquer, but a foil overlay may also be provided or the surface may be metallised). As a result, it is possible to reflect the light emitted by the mouse onto the optical sensor. Due to attachment of the reflective layer to the platform's height-adjustable cover, the height of the mouse in relation to the cover depends on the deflection of the platform. An adjusting screw is used to fine-tune the height of the reflective layer in relation to the mouse (FIG. 9). (501: cover, height-adjustable; 502 plate of metal, glass, Teflon, plastic; 503 laser; 504 mouse; 505 optical detector; 506 curvature; 507 wire with spring; 508 reflective layer; 509 adjusting screw)

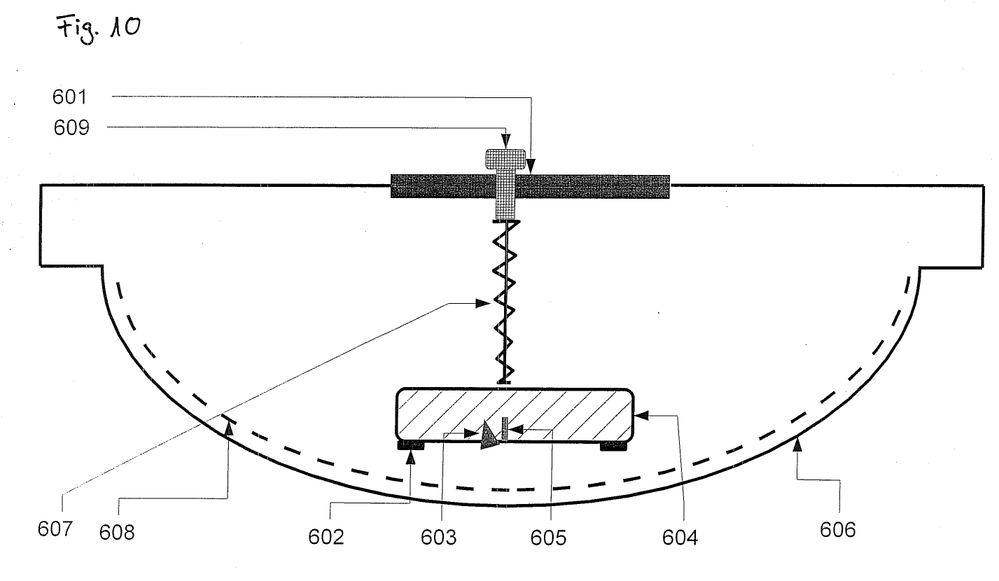

In a balance board (FIG. 10) (platform with hemispherical curvature), a pendulum wire is used to attach a mouse to the platform or to a cover set into the platform. The mouse's optical sensor faces towards the curvature and the light emitted by the mouse is reflected onto the optical sensor using a reflective layer, which has been applied to the curvature and comprises, for example, lacquer, paint, foil or metallisation. A spring which is fitted over the pendulum wire is used to damp the dithering of the mouse pointer during use. Due to attachment of the mouse to the platform or the cover in the platform, the height of the pendulum which arises depends on the deflection of the platform. An adjusting screw is used to fine-tune the height of the mouse in relation to the reflective layer (see FIG. 10). The device comprises a cover 601; mouse feet 602 of metal, glass, Teflon, plastic; laser 603; mouse 604; optical detector 605; curvature 606; wire with spring 607; reflective layer 608; adjusting screw 609.

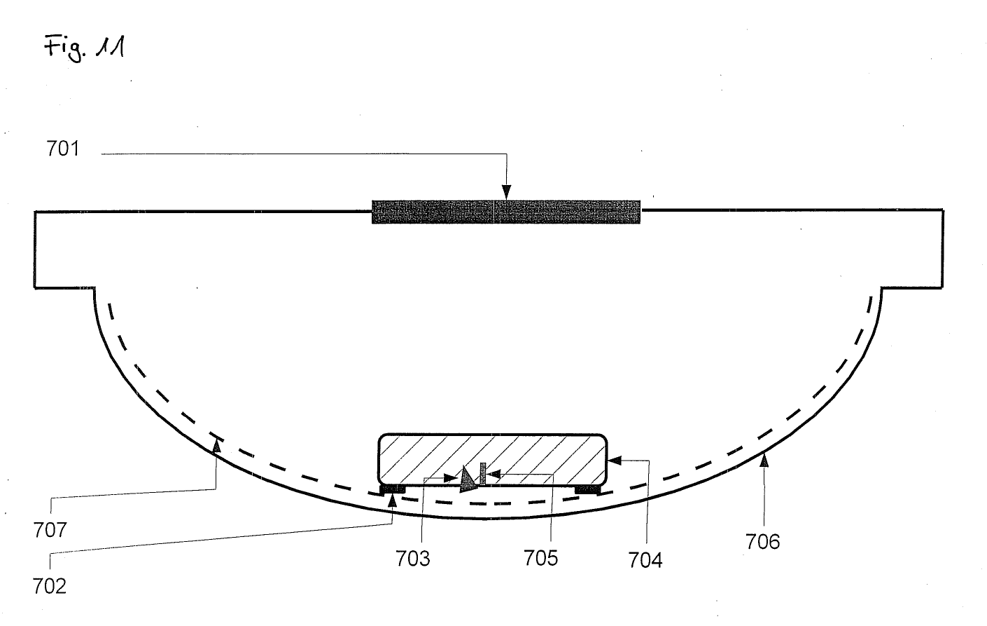

In yet a further embodiment of a balance board (FIG. 11) (platform with hemispherical curvature), a mouse is positioned in the curvature. The mouse's weight distribution has been adapted such that rotation of the mouse is largely excluded during movement in the curvature and the result is mainly translation of the mouse in the curvature. The mouse's optical sensor faces towards the curvature and the light emitted by the mouse is reflected onto the optical sensor using a reflective layer in the curvature which comprises, for example, lacquer, paint, foil or metallisation. The mouse is mobile on the reflective layer. The mouse has been balanced from the weight aspect in order to ensure its spatial stability. The mouse's reaction inertia damps the dithering of the mouse pointer during use. This arrangement does not depend on the deflection of the platform. In order to guarantee easy mobility of the mouse, the mouse has plates of metal, glass, Teflon or other plastics with good sliding properties. Moreover, the use of balls is also possible. According to FIG. 11, the device comprises a: cover 701; mouse feet 702 of metal, glass, Teflon, plastic, that are designed as a plate or ball; laser 703; mouse 704; optical detector 705; curvature 706; reflective layer 707.

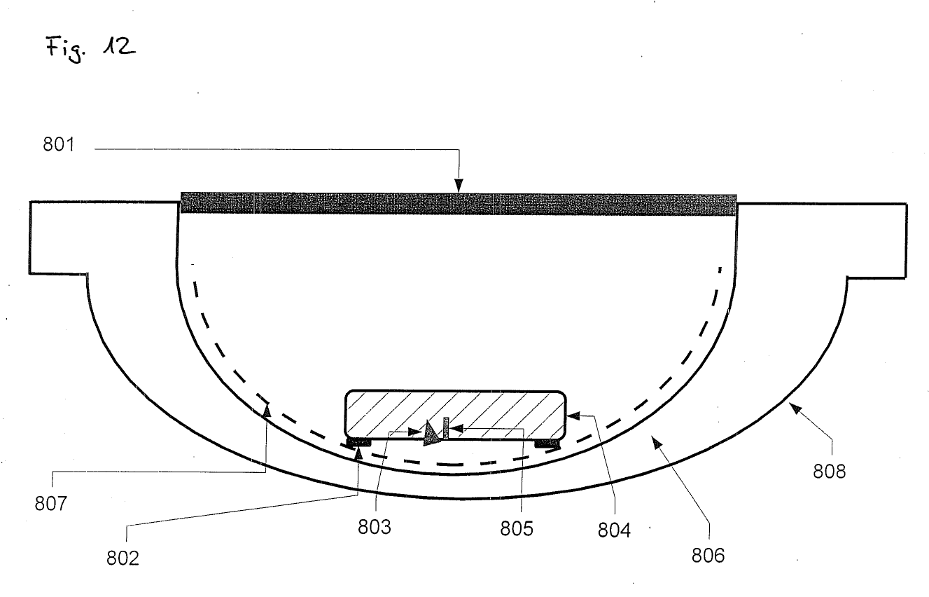

In yet a further embodiment, a mouse is placed in the curvature of a balance board (FIG. 12) (platform with hemispherical curvature). The mouse's weight distribution has been adapted such that rotation of the mouse is largely excluded during movement in the curvature and the result is mainly translation of the mouse in the curvature. The mouse's optical sensor faces towards the curvature and the light emitted by the mouse is reflected onto the optical sensor using a reflective layer in the curvature which comprises, for example, lacquer, paint, foil or metallisation. The mouse is mobile on the reflective layer. The mouse's reaction inertia damps the dithering of the mouse pointer during use. This arrangement does not depend on the deflection of the platform. Unlike the previous example, the diameter of the inner curvature is smaller in this case than the diameter of the outer curvature. Easy mobility of the mouse is possible by choosing the appropriate ratios. Thus mice which are 7 cm long can slide well in an inner curvature with an internal diameter of 23 cm. The device comprises a cover 801, mouse feet 802 of metal, glass, Teflon, plastic; a laser 803; a mouse 804; an optical detector 805; an inner curvature 806; a reflective layer 807; and an external curvature 808).

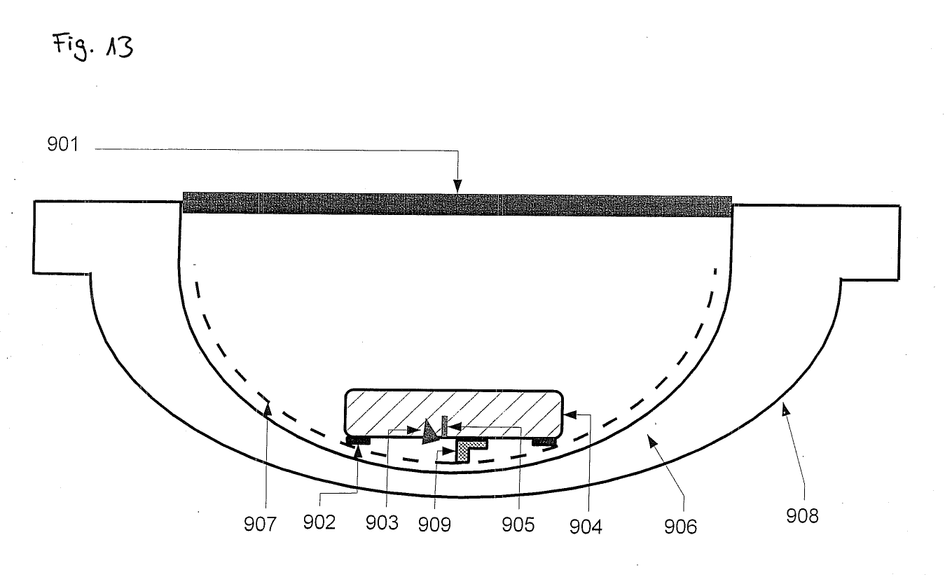

In yet a further embodiment (FIG. 13), (platform with hemispherical curvature), a mouse is placed in the curvature. The mouse's weight distribution has been adapted such that rotation of the mouse is largely excluded during movement in the curvature and the result is mainly translation of the mouse in the curvature. The mouse's optical sensor faces towards the curvature and the light emitted by the mouse is reflected onto the optical sensor using a reflective layer in the curvature which comprises, for example, lacquer, paint, foil or metallisation. The mouse is mobile on the reflective layer. The mouse's reaction inertia damps the dithering of the mouse pointer during use. This arrangement does not depend on the deflection of the platform. Unlike the previous example, the diameter of the inner curvature is smaller in this case than the diameter of the outer curvature. Easy mobility of the mouse is possible by choosing the appropriate ratios. Thus mice which are 7 cm long can slide well in an inner curvature with an internal diameter of 23 cm. The reflective beam attached underneath serves with a larger gap to reflect the mouse's light onto the reflective layer. The reflective beam may also be designed as an angle bracket. It is bonded to the underside of the mouse or attached with screws. This comprises a cover 901, mouse feet 902 of metal, glass, Teflon, plastic, laser 903, mouse 904, optical detector 905, inner curvature 906, reflective layer 907, outer curvature 908, reflective angle bracket 909.

### List of Reference Numbers

10 User interface controller

11 Platform

12 Person

13 Analog inclination sensor

14 Board

15 Sliding sensor

16 Acceleration sensor or inclination sensor

17 Battery unit and transformer unit

18 Feet

19 Pressure sensor

20 Spherical segment

21 Vibration drive

101 Cover

102 Plate of plastic or metal

103 Laser

104 Mouse

105 Optical detector

106 Mountings for mouse, remote release

107 Wire with spring

108 Remote release

109 Adjusting screw

110 Frame for wire suspension

201 Cover

202 Plate of plastic or metal

203 Laser

204 Mouse

205 Optical detector

206 Mountings for mouse, remote release

207 Wire with spring

208 Remote release

209 Adjusting screw

210 Insert

301 Cover

302 Plate of plastic or metal

303 Laser

304 Mouse

305 Optical detector

306 Mountings for mouse, remote release

307 Wire with spring

308 Remote release

309 Adhesive or adhesive tape for fixing mouse

310 Adjusting screw

401 Cover, height adjustable

402 Plate of plastic or metal

403 Laser

404 Mouse

405 Optical detector

406 Mountings for mouse, remote release

407 Wire with spring

408 Remote release

409 Adjusting screw

501 Cover, height adjustable

502 Plate of metal, glass, Teflon, plastic

503 Laser

504 Mouse

505 Optical detector

506 Curvature

507 Wire with spring

508 Reflective layer

509 Adjusting screw

601 Cover

602 Mouse feet of metal, glass, Teflon, plastic

603 Laser

604 Mouse

605 Optical detector

606 Curvature

607 Wire with spring

608 Reflective layer

609 Adjusting screw

701 Cover

702 Mouse feet of metal, glass, Teflon, plastic shaped as a plate or ball

703 Laser

704 Mouse

705 Optical detector

706 Curvature

707 Reflective layer

801 Cover

802 Mouse feet of metal, glass, Teflon, plastic

803 Laser

804 Mouse

805 Optical detector

806 Inner curvature

807 Reflective layer

808 Outer curvature

901 Cover

902 Mouse feet of metal, glass, Teflon, plastic

903 Laser

904 Mouse

905 Optical detector

906 Inner curvature

907 Reflective layer

908 Outer curvature

909 Reflection angle

1. A user interface controller for controlling a computer comprising:
a platform, which is designed such that for use it is disposed parallel to the ground and which is strong enough and large enough for a person to get onto the platform,
a support of the platform which creates the contact with the floor,
at least one inclination sensor, which is connected to the platform and which records the shift in the person's movement on the platform and converts it into an electronic signal, whereby
the inclination sensor has a sliding surface on which a sliding detector, such as a mouse, slides such that movements on the platform lead to various positions of the sliding detector which are detectable by said sliding detector or
whereby the inclination sensor has a pendulum element which is disposed such that an inclination of the platform brings about a deflection of the pendulum element, said deflection being detectable by an oscillation detector,
a controller which receives the sensor's electronic signals and converts them into digital signals which can be processed by the computer such that the movements can be interpreted as a user input.

2. The user interface controller according to claim 1, whereby a vibration drive keeps the sliding surface in motion such that the rolling resistance or the frictional resistance is minimised.

3. The user interface controller according to claim 1, whereby the sliding surface has a reflective layer which enables motion detection or position detection.

4. The user interface controller according to claim 1, whereby the sliding surface is coated such that a low frictional resistance exists, such as a Teflon coating.

5. The user interface controller according to claim 1, whereby for controlling a computer, where an optical sensor is attached underneath the platform, the sensor's optical path is reflected by a plate whereby the plate is attached to the platform as a pendulum using a pendulum material or is attached to the platform by way of a frame whereby the position of the platform is ascertainable by the type of reflection.

6. The user interface controller according to claim 1, whereby the sensor is attached to the platform as a pendulum using a pendulum material or is attached to the platform by way of a frame, and the sensor's optical path is reflected by a plate, whereby the plate is attached to the platform.

7. The user interface controller according to claim 5, whereby the pendulum is either suspended or stands upright and is held in the upright position by a flexible material.

8. The user interface controller according to claim 6, whereby the pendulum is either suspended or stands upright and is held in the upright position by a flexible material.

9. The user interface controller according to claim 7, whereby the pendulum material is a cord, a wire or a spring.

10. The user interface controller according to claim 8, whereby the pendulum material is a cord, a wire or a spring.

11. The user interface controller according to claim 6, wherein the pendulum has one or more of the following functions: the pendulum is adjustable in its height the pendulum is adjustable in its pendulum length, a disc for even contact of the spring against the fixed point or a disc for even contact of the spring against the plate may be added to the pendulum, the pendulum may be triggered by a keystroke by means of a wire-based or pneumatic remote release, the oscillations of the pendulum are damped when using wire or cord by means of a larger diameter or a spring which runs around the wire or cord at a distance therefrom.

12. The user interface controller according to claim 6, whereby
the plate is comprised of optically reflective material, such as metal, lacquer, paint, foil, metallisation or the pendulum material includes wire or cord.

13. The user interface controller according to claim 6, whereby the sensor is a mouse which is located in a curvature underneath the platform, the base under the mouse is reflective, the curvature is constructed such that the mouse moves therein and the reflective so that light falls on the background under the sensor.

14. The user interface controller according to claim 13, whereby the ratio of the diameter of the curvature to the length of the mouse lies in the range of 23:9.

15. The user interface controller according to claim 1, whereby the sensor is disposed underneath or inside the platform.

16. The user interface controller according to claim 1, whereby a spherical segment which permits tilting movements of the platform is disposed underneath the platform as a support.

17. The user interface controller according to claim 1, whereby resilient feet which permit tilting movements of the platform are disposed underneath the platform as a support.

18. The user interface controller according to claim 1, whereby the digital signals of the controller are transmitted to the computer wirelessly or by wire.

19. The user interface controller according to claim 18, whereby the digital signals are transmitted via one of the following ports: USB, serial, Bluetooth, FireWire, wireless, infrared or any other ports.

20. The user interface controller according to claim 19, whereby the signals transmitted reflect the input of a keyboard or a mouse.

21. The user interface controller according to claim 1, whereby the platform is preferably circular and has a diameter of approx. 20-120 cm such that a person can stand on it.
